(19) United States
(12) Patent Application Publication
(10) Pub. No.: US 2025/0351943 A1
(43) Pub. Date: Nov. 20, 2025

(54) BACKPACK POWER EQUIPMENT

(71) Applicant: BLACK & DECKER, INC., New Britain, CT (US)

(72) Inventors: Ryan WUERFL, Parkville, MD (US); Pashupati Dhakal, Middle River, MD (US); Robert Jackson, Waddell, AZ (US); Paul A. Stephenson, Parkville, MD (US); Conor Hantzschel, New Britain, CT (US); Arpit Singhal, Kitchener, CA (US); Nick Lowe, Lutherville-Timonium, MD (US); Colin M. Crosby, Baltimore, MD (US); Gregory Ray Kern, Gilbert, AZ (US); Evan Robert Bottom, Rockville, MD (US); Carl Malia, New Britain, CT (US)

(73) Assignee: BLACK & DECKER, INC., New Britain, CT (US)

(21) Appl. No.: 18/665,150

(22) Filed: May 15, 2024

(51) Int. Cl. A45F 3/04; A01G 20/47; A45F 3/00; F04D 19/00; F04D 25/06; F04D 29/66; H01M 10/42; H01M 50/204; H01M 50/247

(52) U.S. Cl. CPC A45F 3/04; A01G 20/47; F04D 19/002; F04D 25/0673; F04D 29/663; H01M 10/425; H01M 50/204; H01M 50/247; A45F 2003/003; A45F 2003/045; H01M 2010/4271; H01M 2220/30

(57) ABSTRACT

According to examples, a backpack power equipment may include a power equipment, a base frame to be worn on a user's back, a connecting member connecting the power equipment to the base frame about an axis at a first height from a bottom of the base frame, a motor controller module mounted to the base frame, and a battery management module mounted to the base frame. The motor controller module and the battery management module are both positioned above the first height. By positioning the motor controller module and the battery management module above the first height, more of the weight may be at a higher position, which may enable a user to maintain a more upright posture during use, which may improve ergonomics of the backpack power equipment disclosed herein.

### FIELD

The present disclosure is directed to power equipment. Particularly, the present disclosure is directed to backpack power equipment, such as axial blowers, connected to a backpack base frame to be worn on a user of the backpack. Various modules and other components of the backpack power equipment may be positioned on the base frame to enable the backpack power equipment to have improved ergonomics.

### BACKGROUND

Power equipment, such as garden machines, typically include a motor or an engine powered by electricity or fossil fuels. Such power equipment include blowers, such as leaf blowers, string trimmers, and edgers. In some of these power equipment, some of the heavier components of the power equipment are provided on a backpack to reduce the arm stress and fatigue on a user of the power equipment.

### SUMMARY

This section provides a general summary of the disclosure, and is not a comprehensive disclosure of its full scope or all of its features.

According to embodiments disclosed herein, a backpack power equipment includes a power equipment, a base frame to be worn on a user's back, a connecting member connecting the power equipment to the base frame about an axis at a first height from a bottom of the base frame, a motor controller module mounted to the base frame, and a battery management module mounted to the base frame. The motor controller module and the battery management module are both positioned above the first height.

According to embodiments disclosed herein, a backpack blower includes a base frame to be worn on a user of the backpack blower's back, an axial blower having a motor, a connecting member connecting the axial blower to the base frame at a first height from a bottom of the base, in which the connecting member enables the axial blower to be rotatable with respect to the base frame. The backpack blower also includes a first module to control the motor of the axial blower and a second module to manage operation of at least one battery electrically connected to the base frame. The first module and the second module are both mounted on the base frame to cause an upper portion of the base frame above the first height to be heavier than a lower portion of the base frame below the first height.

According to embodiments disclosed herein, backpack blower includes a base frame to be worn on a user of the backpack blower's back, the base frame including a stand having a foot that extends in one direction from the stand, in which the stand and the foot are to hold the backpack blower at an upright position when the backpack blower is positioned on a horizontal surface. The backpack blower also includes an axial blower having a motor, a connecting member connecting the axial blower to the base frame at a first height from a bottom of the base, in which the connecting member enables the axial blower to be vertically rotatable with respect to the base frame. The backpack blower also includes a first module including electronics to control the motor of the axial blower and a second module including electronics to manage operation of at least one battery electrically connected to the base frame, in which the first module and the second module are both mounted on the base above the first height to cause an upper portion of the base frame above the first height to be heavier than a lower portion of the base frame below the first height.

### BRIEF DESCRIPTION OF THE DRAWINGS

Features of the present disclosure are illustrated by way of example and not limited in the following figure(s), in which like numerals indicate like elements, in which:

FIG. 1A shows a perspective view of a backpack power equipment, in accordance with an embodiment of the present disclosure;

FIGS. 1B and 1C, respectively, show rear views of the backpack power equipment shown in FIG. 1A, in which a power equipment is in a lowered and a raised position, in accordance with an embodiment of the present disclosure;

FIG. 1D shows a diagram of a harness of the backpack power equipment shown in FIGS. 1A-1C, according to an embodiment of the present disclosure;

FIG. 1E shows a perspective view of the battery guard shown in FIGS. 1A-1C, in accordance with an embodiment of the present disclosure;

FIG. 2 shows a perspective view of the backpack power equipment shown in FIGS. 1A-1C, in which the connecting member is shown in an exploded view, in accordance with an embodiment of the present disclosure;

FIG. 3 shows a block diagram of various components of the backpack power equipment shown in FIGS. 1A-1C, in accordance with an embodiment of the present disclosure; and

FIGS. 4A-4B, respectively, show diagrams of an assembly including the motor and a fan of the power equipment shown in FIGS. 1A-1C, in accordance with an embodiment of the present disclosure.

### DETAILED DESCRIPTION

Backpack power equipment, such as leaf blowers attached to backpacks, have gained in popularity because the backpack power equipment make it easier for operators of the power equipment to carry and use the power equipment, which allows for larger batteries that provide longer runtimes to be employed. Particularly, for instance, as the engines and/or batteries of the backpack power equipment are typically the heaviest components in the power equipment, the engines and/or batteries are provided on the backpacks. By placing the heavier components on the backpack, an operator's shoulders may support the weights of these components. As a result, stress and fatigue on the operator's arm may be reduced.

Disclosed herein are backpack power equipment, such as backpack blowers, backpack axial blowers, backpack leaf blowers, and/or the like, that may include features to improve ergonomics of the backpack power equipment in addition to other improvements. As a result, usability of the backpack power equipment may be improved, which may further reduce arm stress and fatigue on a user of the backpack power equipment. The backpack power equipment may also include a foot that may extend outside of a center of gravity of the backpack power equipment to assist in supporting the backpack power equipment in an upright position when the backpack power equipment is placed on a substantially horizontal surface. Additionally, the motor shaft of the power equipment may have a runout that may be used to determine whether the angle of the shaft, and thus, a fan connected to the shaft is deformed. By making this determination, a determination may be made as to whether the fan is likely to contact a baffle without disassembling the fan assembly.

According to examples, the backpack power equipment disclosed herein may include a power equipment, such as a leaf blower, an axial blower, and/or the like, a base frame to be worn on a user's back, and a connecting member connecting the power equipment to the base frame about an axis at a first height from a bottom of the base frame. In some examples the connecting member is rotatably connected to the power equipment and the axis is a pivot axis. The backpack power equipment also includes a motor controller module mounted to the base frame and a battery management module mounted to the base frame. The motor controller module and the battery management module are both positioned above the first height. By positioning the motor controller module and the battery management module above the first height, more of the weight may be at a higher position, which may enable a user to maintain a more upright posture during use, which may improve ergonomics of the backpack power equipment disclosed herein.

Before continuing, it is noted that as used herein, the terms “includes” and “including” mean, but are not limited to, “includes” or “including” and “includes at least” or “including at least.” The term “based on” means, but is not limited to, “based on” and “based at least in part on.”

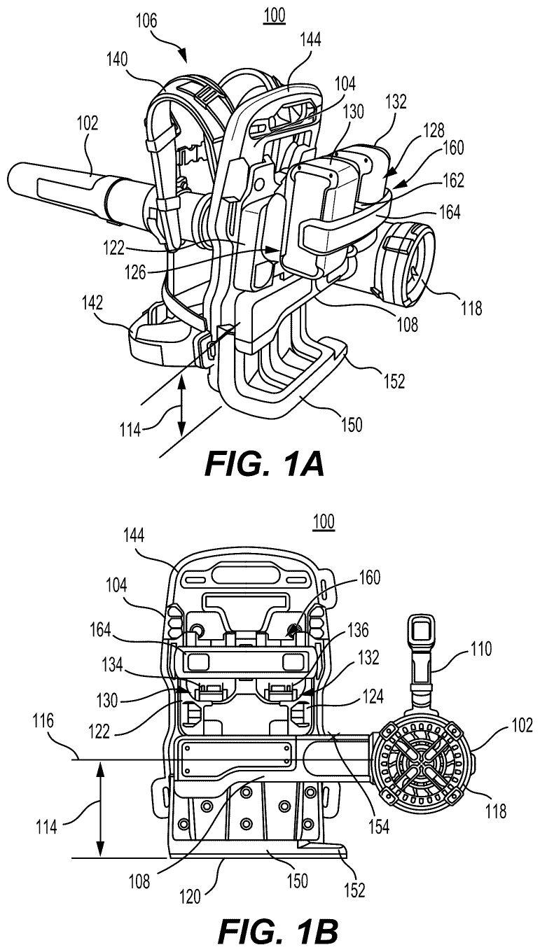

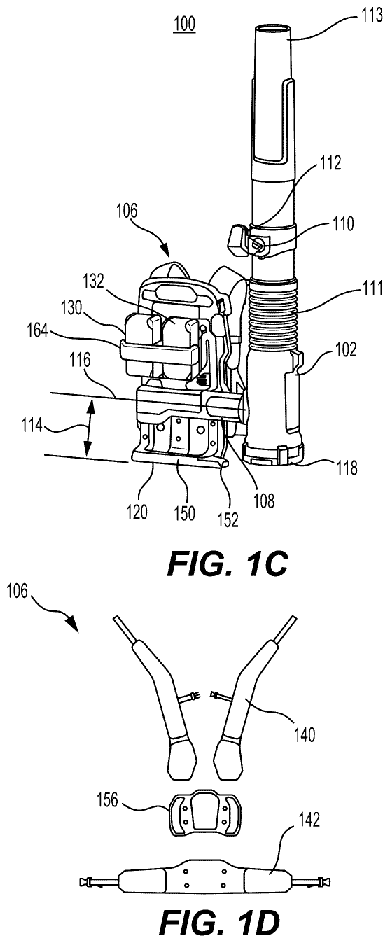

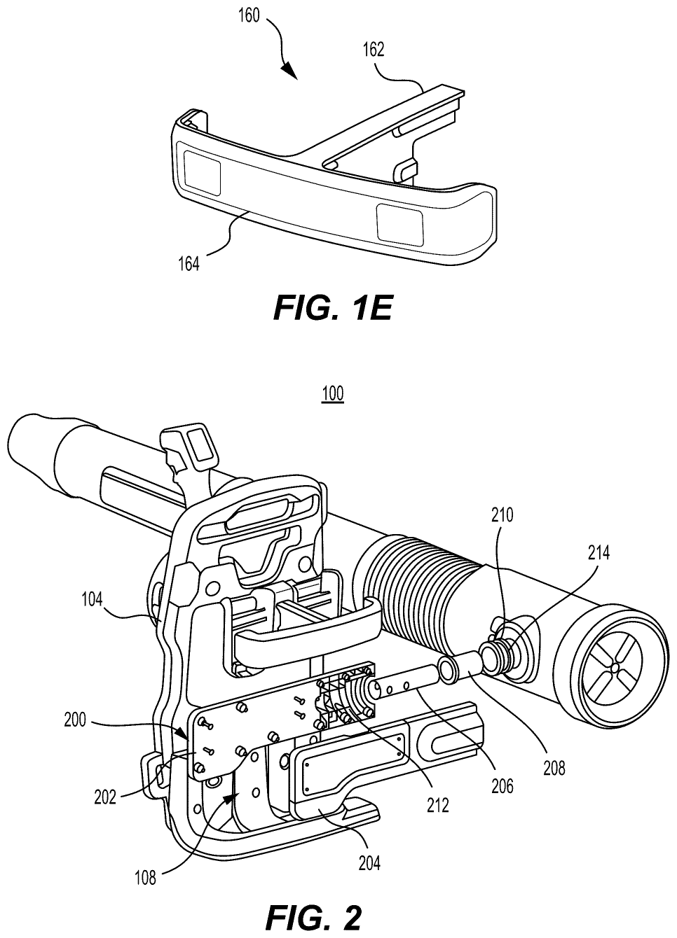

FIG. 1A shows a perspective view of a backpack power equipment 100, in accordance with an embodiment of the present disclosure. FIGS. 1B and 1C, respectively, show rear views of the backpack power equipment 100 shown in FIG. 1A, in which a power equipment 102 is in a lowered and a raised position, in accordance with an embodiment of the present disclosure. It should be understood that the power equipment 100 depicted in FIGS. 1A-1C may include additional components and that some of the components described herein may be removed and/or modified without departing from the scope of the backpack power equipment 100 disclosed herein. It should also be understood that the components depicted in FIGS. 1A-1C are located in certain positions for purposes of illustration and should thus not be construed as limiting the backpack power equipment 100 solely to what is shown in those figures.

As shown in FIGS. 1A-1C, the backpack power equipment 100 may include a power equipment 102, a base frame 104, and a harness 106. The base frame 104 may be formed of a substantially rigid material, such as a hard plastic, a composite material, a metal, and/or the like. In addition, the base frame 104 may include any number of features, such as slots, openings, supports, and/or the like, that enable components of the backpack power equipment 100 to be mounted or strapped to or on the base frame 104. The base frame 104 may further include additional features that enable the backpack power equipment 100 to be carried and used by a user as discussed herein.

According to examples and as shown in FIGS. 1A-1C, the power equipment 102 is an axial blower. In other examples, the power equipment 102 may be other types of power equipment that may rotatably be mounted to the base frame 104. For instance, the power equipment 102 may be a garden tool, such as a string trimmer, an edger, a clipper, a chainsaw, and/or the like.

The power equipment 102 may be connected to the base frame 104 through a connecting member 108. The connecting member 108 may rigidly be mounted or otherwise connected to a rear side of the base frame 104 and may include components that enable the power equipment 102 to rotate with respect to the base frame 104. The power equipment 102 may be connected to the base frame 104 such that the power equipment 102 may be rotated vertically with respect to the base frame 104. In other examples, the connecting member 108 may enable the power equipment 102 to move in additional or other manners, such as both horizontally and vertically. In some examples, the power equipment 102 may include a handle 110 that a user may grasp to maneuver the power equipment 102 and a trigger 112 that the user may depress to activate a motor (not shown) within power equipment 102. Additional controls and/or indicators may also be provided on the handle in some examples.

As shown in FIG. 1C, the power equipment 102 may also include a flexible tube portion 111 that may enable a free end 113 of the power equipment 102 to be movable with respect to the portion of the power equipment 102 connected to the connecting member 108. For instance, the flexible tube portion 111 may enable the free end 113 to be moved in any of multiple directions with respect to the portion of the power equipment 102 connected to the connecting member 108.

As shown in FIGS. 1A-1C, the connecting member 108 connects the power equipment 102 to the base frame 104 at a first height 114 from a bottom end 120 of the base frame 104, for instance, from a bottom of a stand 150. In addition, the power equipment 102 is rotatable with respect to the base frame 104 about an axis 116 and the axis 116 coincides with the first height 114 from the bottom end 120 of the base frame 104. In some examples, the first height 114 is selected to enable the power equipment 102 to rotate about the axis 116, e.g., the axis 116 is a pivot axis 116, between the position shown in FIG. 1B and the position shown in FIG. 1C, such that a rear end 118 of the power equipment 102 is at a height that is above the height of the bottom end 120 of the base frame 104. For instance, the first height 114 and the location of the pivot axis 116 on the power equipment 102 may enable the power equipment 102 to rotate between horizontal and vertical positions while the base frame 104 is rested on a horizontal surface. In some examples, the power equipment 102 may be rotated between the horizontal and vertical positions while the base frame 104 is rested on a horizontal surface without obstruction.

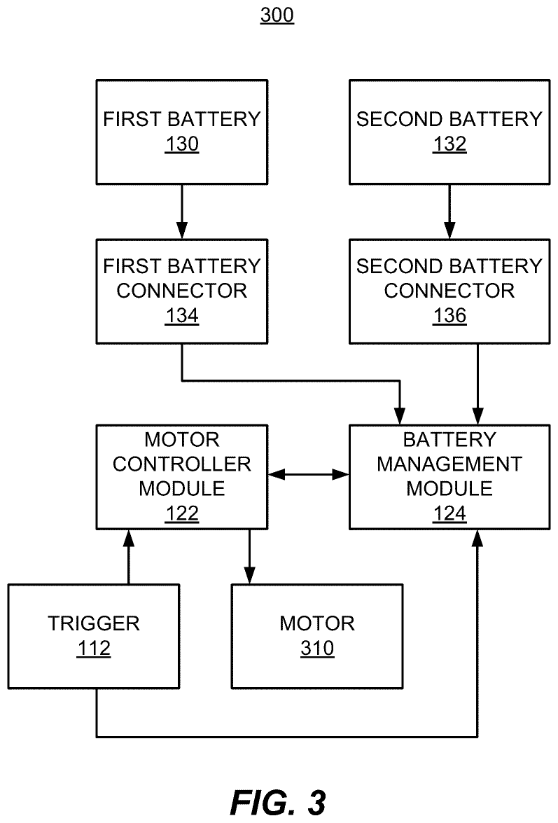

According to examples, the backpack power equipment 100 includes a motor controller module 122 mounted to the base frame 104 and a battery management module 124 mounted to the base frame 104. In FIG. 1A, the motor controller module 122 and the battery management module 124 are hidden from view. The motor controller module 122 and the battery management module 124 may each be contained within housings. As discussed in greater detail herein with respect to FIG. 3, the motor controller module 122 may control operations of the motor contained in the power equipment 102 and the battery management module 124 may manage various operations of batteries mounted on the backpack power equipment 100.

The backpack power equipment 100 is depicted as including at least one battery compartment 126, 128 to support at least one battery 130, 132. The batteries 130, 132 are omitted from FIG. 1B. The battery compartments 126, 128 may each include a battery connector 134, 136 (FIG. 1B) to which the respective batteries 130, 132 may be connected. That is, for instance, a first battery 130 may be inserted into a first battery compartment 126 by being moved downward and into the first battery compartment 126. Likewise, a second battery 132 may be inserted into a second battery compartment 128 by being moved downward and into the second battery compartment 128. When the first battery 130 is inserted into the first battery compartment 126, a connector (not shown) on the first battery 130 may come into electrical contact with a first battery connector 134. Likewise, when the second battery 132 is inserted into the second battery compartment 132, a connector (not shown) on the second battery 132 may come into electrical contact with a second battery connector 136. As a result, power from the batteries 130, 132 may be provided to the power equipment 102 through the first and second battery connectors 134, 136 and through wiring extending through the connecting member 108.

As shown in FIGS. 1A-1C, the motor controller module 122 and the battery management module 124 may be positioned between the first battery compartment 130 and the second battery compartment 132 and the base frame 104. For instance, the motor controller module 122 may be positioned between the first battery compartment 130 and the base frame 104 and the battery management module 124 may be positioned between the second battery compartment 132 and the base frame 104. The first and second battery connectors 134, 136 may thus be in relatively close proximities to the motor controller module 122 and the battery management module 124. As a result, the wiring from the first and second battery connectors 134, 136 to the motor controller module 122 and the battery management module 124 may be relatively short, which may enable for relatively no loss in voltage or current from the batteries 130, 132 and thus optimize performance. In addition, the relatively short distance of the wiring may reduce costs and decrease packaging size.

In addition, the motor controller module 122 and the battery management module 124 may both be positioned above the first height 114 (and consequently, the first and second batteries 130, 132 as well). By positioning the motor controller module 122 and the battery management module 124 above the first height 114 (and the first and second batteries 130, 132) as discussed herein, the ergonomics of the backpack power equipment 100 may be improved. That is, the weight of the backpack power equipment 100 may be higher above the first height 114 than below the first height 114. By placing more of the weight at a higher position of the backpack power equipment 100, a user may be able to maintain a more upright posture during use, which may reduce strain on the user's back. This may also reduce overall fatigue of the user and increase the amount of time that the user may use the backpack power equipment 100.

The harness 106 is depicted in FIG. 1A as including a pair of shoulder straps 140 and a hip strap 142. As shown in FIG. 1D, the harness 106 may also include a lumbar support 156 to which the shoulder straps 140 and the hip strap 142 may be connected. In some examples, the shoulder straps 140 may also be removably connected to the base frame 104, while the hip strap 142 may removably be connected to the lumbar support 156. Thus, for instance, a user may remove the hip strap 142 in instances in which the user does not need or wish to use the hip strap 142. A user of the backpack power equipment 100 may use the backpack power equipment 100 by placing the shoulder straps 140 on the user's shoulders and strapping the hip strap 142 around their hips. In addition, the user may grasp the handle 110 and maneuver the power equipment 102 to various positions. In some examples, the lumbar support 156 may permanently be mounted to the base frame 104, while in other examples, the lumbar support 156 may releasably be mounted to the base frame 104. In some examples, the hip strap 142 may also be permanently or directly mounted to the base frame 104.

As shown in FIGS. 1A-1C, the base frame 104 may support the components of the backpack power equipment 100 and may provide additional features. For instance, an upper portion of the base frame 104 may form a base frame handle 144 that a user may use to grasp and hold the backpack power equipment 100. In addition, a stand 150 may be mounted to a bottom section of the base frame 104, for instance, through the use of mechanical fasteners. In other examples, the stand 150 may be formed integrally with the base frame 104. In any of these examples, the stand 150 may assist in supporting the backpack power equipment 100 in an upright position when the backpack power equipment 100 is placed on a substantially horizontal surface.

FIG. 1B shows a center of gravity 154 (denoted by an “x”) of the backpack power equipment 100 when the first and second batteries 130, 132 are not mounted. In some examples, the backpack power equipment 100 may also include a foot 152 that extends away from the stand 150 and in a direction toward the power equipment 102. Particularly, the foot 152 may extend at a location from the stand 150 that is outside of the center of gravity 154, e.g., when the batteries 130, 132 are not mounted to the battery connectors 134, 136. As a result, the foot 152 assists in holding the base frame 104 in a substantially upright position when the backpack power equipment 100 is placed on a substantially horizontal surface. That is, the power equipment 102 may cause the backpack power equipment 100 to be weighted toward the power equipment 102 and the foot 152 may prevent the backpack power equipment 100 from tilting over. The foot 152 may prevent the backpack power equipment 100 from tilting over toward the power equipment 102 while the power equipment 102 is in a lower position as shown in FIGS. 1A and 1B. In addition or in other examples, the foot 152 may prevent the backpack power equipment 100 from tilting over while the power equipment 102 is in a vertical position as shown in FIG. 1C.

In some examples, the foot 152 may be formed integrally with the stand 150, while in other examples, the foot 152 may be separate from the stand 150 and may be attached to the stand 150, e.g., through use of an adhesive, welding, mechanical fasteners, and/or the like. The foot 152 may extend at a certain distance from the stand 150, in which the certain distance may depend upon, for instance, the weight of the base frame 104, the weights of the components mounted to the base frame 104, the weight of the power equipment 102, the location of the center of gravity 154, and/or the like. The length of the foot 152 may be determined through testing, modeling, historical data, and/or the like, and may differ for different backpack power equipment 100. By way of particular examples, the foot 152 may have a length having a distance anywhere between around 20 mm and around 80 mm.

As shown in FIGS. 1A-1C, the backpack power equipment 100 may also include a battery guard 160 that may form the first battery compartment 130 and the second battery compartment 132. The battery guard 160 may include a first portion 162 that is cantilevered from the base frame 104 as shown in FIG. 1A. The first portion 162 may extend between the first battery compartment 130 and the second battery compartment 132. Additionally, the first portion 162 may separate the first battery 130 from the second battery 132. As shown in FIG. 1E, which shows a perspective view of the battery guard 160, in accordance with an embodiment of the present disclosure, the battery guard 160 may also include a second portion 164 connected to a free end of the first portion 162 such that, for instance, the first portion 162 and the second portion 164 form a substantially “T” shape. In other examples, the battery guard 160 may have other shapes. For instance, the ends of the battery guard 160 may also connect to the base frame 104. The battery guard 160 may cover portions of the batteries 130, 132 and may thus protect the batteries 130, 132.

Turning now to FIG. 2, there is shown a perspective view of the backpack power equipment 100 shown in FIGS. 1A-1C, in which the connecting member 108 is shown in an exploded view, in accordance with an embodiment of the present disclosure. As shown in FIG. 2, the connecting member 108 may include a housing 200 that may be formed of a first part 202 and a second part 204. The first part 202 may be mounted to the base frame 104 and the second part 204 may removably be mounted to the first part 202.

The connecting member 108 may also include a tube 206 that may rigidly be constrained in the housing 200 when the tube 206 is held between the first part 202 and the second part 204 of the housing 200. The connecting member 108 may further include a sleeve 208 that may provide a relatively smooth surface over which a connector 210 mounted on the power equipment 102 may rotate with respect to the tube 206.

In some examples, the range over which the power equipment 102 may move with respect to the base frame 104 may be limited to a predefined range. In these examples, the first part 202 and the second part 204 of the housing 200 may include limiting ribs 212 and the connector 210 may include tabs 214, in which the ribs 212 and the tabs 214 may restrict the rotational movement of the power equipment 102 with respect to the base frame 104. Particularly, the limiting ribs 212 and the tabs 214 may limit the rotational movement to between upper and lower limits. The predefined range of movement may correspond to a range of movement that enables a user of the backpack power equipment 100 to comfortably and correctly use the backpack power equipment 100. By way of example in which the power equipment 102 is a blower, the range of movement may correspond to a range that enables users to effectively and efficiently use the power equipment 102 on the type of application that the power equipment 102 is suited, such as clearing debris. The predefined range of movement may also correspond to the type of power equipment 102 connected to the base frame 104 and may thus differ for different types of power equipment 102. In any regard, the predefined range of movement may be determined through testing, modeling, artificial intelligence, historical data, and/or the like. By way of particular example, the upper range of movement may be about 90 degrees from horizontal and the lower range of movement may be about −20 degrees from horizontal.

FIG. 3 shows a block diagram 300 of various components of the backpack power equipment 100, in accordance with an embodiment of the present disclosure. Particularly, the block diagram 300 shown in FIG. 3 may represent a wiring diagram of the various components of the backpack power equipment 100. It should be understood that the block diagram 300 depicted in FIG. 3 may include additional components and that some of the components described herein may be removed and/or modified without departing from the scope of the block diagram 300 disclosed herein. It should also be understood that the components depicted in FIG. 3 are for purposes of illustration and should thus not be construed as limiting the backpack power equipment 100 to the components and arrangements shown therein.

As shown in FIG. 3, the first battery 130 may be connected to the first battery connector 134 and the second battery 132 may be connected to the second battery connector 136. The first battery connector 134 and the second battery connector 136 may be connected to the battery management module 124. The trigger 112 may also be connected to the motor controller module 122 and the battery management module 124. In addition, the motor controller module 122 may be connected to the battery management module 124 and a motor 310 of the power equipment 102. Particularly, for instance, a user may depress the trigger 112, which may cause a signal to be sent to the motor controller module 122 to output power to the motor 310. In addition, the motor controller module 122 may vary the amount of power outputted to the motor 310 based on the amount of pressure being applied to the trigger 112.

According to examples, the motor controller module 122 may include circuitry (or equivalently, electronics, logic blocks, etc.) to convert energy stored in the first and second batteries 130, 132 into motion of the motor 310. For instance, the motor controller module 122 may ensure that the motor 310 receives the correct amount of power corresponding to the trigger 112 movement. The motor controller module 122 may also regulate the speed and acceleration of the motor 310 based on the trigger 112 input.

According to examples, the battery management module 124 may include circuitry (or equivalently, electronics, logic blocks, etc.) to oversee and manage the first and second batteries 130, 132. For instance, the battery management module 124 may safeguard the cells in the first and second batteries 130, 132 from damage due to overcharging of over-discharging. The battery management module 124 may also ensure that the first and second batteries 130, 132 operate within their safe operating ranges. The battery management module 124 may further continuously monitor various battery parameters such as voltage, temperature, inflow or outflow of current, and/or the like. In some instances, the battery management module 124 may perform calculations based on the monitored data such as estimating remaining charge, assessing operational state, optimizing battery performance, and/or the like.

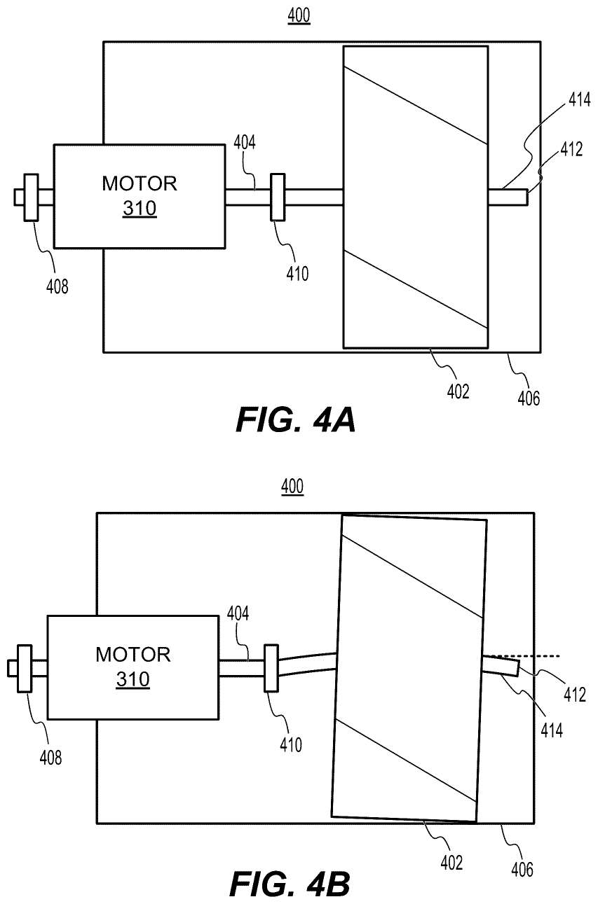

FIGS. 4A and 4B, respectively, show diagrams of an assembly 400 including the motor 310 and a fan 402 of the power equipment 102, in accordance with an embodiment of the present disclosure. It should be understood that the assembly 400 depicted in FIGS. 4A and 4B may include additional components and that some of the components described herein may be removed and/or modified without departing from the scope of the assembly 400 disclosed herein. It should also be understood that the components depicted in FIGS. 4A and 4B are for purposes of illustration and should thus not be construed as limiting the backpack power equipment 100 to the components and arrangements shown therein. For instance, although the motor 310 is shown as being in-line with the fan 402, in other examples, the motor 310 may be positioned above or below a motor shaft 404. In these examples, the motor 310 may be drive the motor shaft 404 through one or more gears.

As shown in FIGS. 4A and 4B, the motor 310 may drive the fan 402 through rotation of the motor shaft 404. The fan 402 is also housed within a baffle 406 such that the fan 402 rotates within the baffle 406. As shown, the ends of the blades in the fan 402 may be in relatively close proximity to the interior wall of the baffle 406. According to examples, the motor 310, the fan 402, the motor shaft 404, and the baffle 406 are housed within the power equipment 102. As a result, when the motor 310 causes the fan 402 to rotate, the fan 402 causes air to flow into the power equipment 102 through an inlet opening at the rear end 118 and through an outlet opening at a front end of the power equipment 102.

The motor shaft 404 is depicted as being supported at two locations, a hall end bearing support 408 and a pinion end bearing support 410. In addition, the fan 402 is depicted as being located outside of the pinion end bearing support 410. In some instances, for instance, when the motor shaft 404 is deformed as shown in FIG. 4B, the fan 402 may be angled and may thus cause the fan 402 blades to come into contact with the interior surface of the baffle 406. The contact between the fan 402 blades and the baffle 406 may cause excessive noise to occur during the fan 402 rotation or might stop the motor 310 from functioning completely. The motor shaft 404 may become deformed, e.g., bent axially, if the fan 402 and the motor shaft 404 are not aligned properly as the fan 402 is pressed onto the motor shaft 404 with an interference fit. The deformation of the motor shaft 404 may eventually result in shifting of the fan radially towards the baffle 406 and create contact between the fan 402 and the baffle 406. In many instances, if this issue is not identified early in the production process, production line shutdown and financial losses may result. However, this issue may not normally be identified after the fan 402 has been fit onto the motor shaft 404 without disassembly of the fan 402 from the motor shaft 404, which may be relatively difficult and time consuming. Disassembly of the fan 402 from the motor shaft 404 may also result in damage to the fan 402.

According to examples disclosed herein, the end 412 of the motor shaft 404 may extend beyond the fan 402 by at least a certain distance. In other words, the end 412 of the motor shaft 404 may overhang 414 the fan 402. The end 412 of the motor shaft 404 may overhang 414 the fan 402 by a distance that is of sufficient length to enable measurement of the motor shaft 404 runout. For instance, a tool for measuring the motor shaft 404 runout, such as a dial indicator, may be used to measure the motor shaft 404 runout.

In some examples, the motor shaft 404 runout may be used to determine whether the assembly 400 has passed or failed inspection. For instance, the motor shaft 404 runout may be used to determine an angle of the fan 402 with respect to the baffle 406. In addition, a determination may be made as to whether the motor shaft 404 runout falls within or is outside of a predefined shaft runout. In instances in which the motor shaft 404 runout falls outside of the predefined shaft runout, the assembly 400 may be determined to have failed the inspection. In these instances, the assembly 400 may be replaced with another assembly. However, in instances in which the motor shaft 404 runout falls within the predefined shaft runout, the assembly 400 may be determined to have passed the inspection. In these instances, the assembly 400 may be moved to a next stage in the power equipment 102 manufacturing process. The predefined shaft runout may be based on historical data of shaft runouts that resulted in failures, based on modeling, testing, and/or the like.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A backpack power equipment comprising:
a power equipment;
a base frame to be worn on a user's back;
a connecting member connecting the power equipment to the base frame about an axis at a first height from a bottom of the base frame;
a motor controller module mounted to the base frame; and
a battery management module mounted to the base frame, wherein the motor controller module and the battery management module are both positioned above the first height.

2. The backpack power equipment of claim 1, wherein the motor controller module is positioned adjacent to the battery management module.

3. The backpack power equipment of claim 1, further comprising:
a battery connector positioned above the first height, wherein the battery connector is to connect to and support a battery.

4. The backpack power equipment of claim 3, wherein the motor controller module and the battery management module are positioned between the battery connector and the base frame.

5. The backpack power equipment of claim 3, further comprising:
a battery guard having:
a first portion cantilevered from the base frame; and
a second portion connected to a free end of the first portion, the second portion having a larger width than the first portion, wherein the battery guard forms a first battery compartment and a second battery compartment, and wherein the second battery compartment is separated from the first battery compartment by the first portion.

6. The backpack power equipment of claim 1, further comprising:
a stand mounted to the base frame below the first height, wherein the stand is to hold the backpack power equipment at an upright position when the backpack power equipment is positioned on a horizontal surface.

7. The backpack power equipment of claim 6, further comprising a foot extending from the stand in a direction toward the power equipment, wherein the foot assists in holding the base frame and the power equipment at the upright position.

8. The backpack power equipment of claim 1, wherein the connecting member comprises:
a housing;
a tube rigidly constrained in the housing; and
a sleeve mounted to the power equipment, wherein the tube is inserted within the sleeve and the sleeve provides a smooth surface about which the tube is to rotate.

9. The backpack power equipment of claim 1, further comprising:
a harness mounted to the base frame, the harness including:
a lumbar support;
a pair of shoulder straps connected to the lumbar support; and
a hip strap removably connected to the lumbar support.

10. The backpack power equipment of claim 1, wherein an upper portion of the base frame above the first height is heavier than a lower portion of the base frame below the first height.

11. A backpack blower comprising:
a base frame to be worn on a user of the backpack blower's back;
an axial blower having a motor;
a connecting member connecting the axial blower to the base frame at a first height from a bottom of the base, wherein the connecting member enables the axial blower to be rotatable with respect to the base frame;
a first module to control the motor of the axial blower; and
a second module to manage operation of at least one battery electrically connected to the base frame, wherein the first module and the second module are both mounted on the base frame to cause an upper portion of the base frame above the first height to be heavier than a lower portion of the base frame below the first height.

12. The backpack blower of claim 11, wherein the first module and the second module are both positioned above the first height.

13. The backpack blower of claim 11, further comprising:
at least one battery connector to connect to and support the at least one battery, wherein the at least one battery connector is mounted to the base frame such that the first module and the second module are positioned between the at least one battery connector and the base frame.

14. The backpack blower of claim 13, further comprising:
a battery guard having:
a first portion extending from the base frame; and
a second portion connected to a free end of the first portion, the second portion having a larger width than the first portion, wherein the battery guard forms a first battery compartment and a second battery compartment, and wherein the second battery compartment is separated from the first battery compartment by the first portion.

15. The backpack blower of claim 11, further comprising:
a stand mounted to the base frame, wherein the stand is to hold the backpack blower at an upright position when the backpack blower is positioned on a horizontal surface; and
a foot extending from the stand in a direction toward the axial blower, wherein the foot assists in holding the base frame at the upright position.

16. The backpack blower of claim 11, further comprising:
a harness mounted to the base frame, the harness including:
a lumbar support;
a pair of shoulder straps connected to the lumbar support; and
a hip strap removably connected to the lumbar support.

17. The backpack blower of claim 11, wherein the axial blower comprises:
a baffle;
a fan housed in the baffle; and
a motor shaft connecting the motor to the fan, wherein a portion of the motor shaft extends beyond an outer surface of the fan, and wherein a runout of the motor shaft is measurable.

18. A backpack blower comprising:
a base frame to be worn on a user of the backpack blower's back, the base frame including a stand having a foot that extends in one direction from the stand, wherein the stand and the foot are to hold the backpack blower at an upright position when the backpack blower is positioned on a horizontal surface;
an axial blower having a motor;
a connecting member connecting the axial blower to the base frame at a first height from a bottom of the base, wherein the connecting member enables the axial blower to be vertically rotatable with respect to the base frame;
a first module comprising electronics to control the motor of the axial blower; and
a second module comprising electronics to manage operation of at least one battery electrically connected to the base frame, wherein the first module and the second module are both mounted on the base above the first height to cause an upper portion of the base frame above the first height to be heavier than a lower portion of the base frame below the first height.

19. The backpack blower of claim 18, further comprising:
at least one battery connector to connect to and support the at least one battery, wherein the at least one battery connector is mounted to the base frame such that the first module and the second module are positioned between the at least one battery connector and the base frame.

20. The backpack blower of claim 19, further comprising:
a battery guard having:
a first portion extending from the base frame; and
a second portion connected to a free end of the first portion, the second portion having a larger width than the first portion, wherein the battery guard forms a first battery compartment and a second battery compartment, and wherein the second battery compartment is separated from the first battery compartment by the first portion.
